(19) United States
(12) Patent Application Publication
(10) Pub. No.: US 2026/0064470 A1
(43) Pub. Date: Mar. 5, 2026

(54) SYSTEMS AND METHODS FOR DYNAMICALLY ALLOCATING RESOURCES TO PERFORM ATOMIC OPERATIONS

(71) Applicant: QUALCOMM INCORPORATED, San Diego, CA (US)

(72) Inventors: Vishal BHUSHAN, Patiala (IN); Vasantha Kumar Bandur PUTTAPPA, Bangalore (IN); Ranjith SRINIVAS A B, Kolar (IN)

(21) Appl. No.: 18/823,276

(22) Filed: Sep. 3, 2024

(51) Int. Cl. G06F 9/50

(52) U.S. Cl. CPC G06F 9/5027

(57) ABSTRACT

Systems and methods are provided for dynamically allocating preselected resources of a system-on-a-chip (SoC) for performing atomic operations in the preselected resources that would otherwise be performed in the NoC when the quantity of resources that is available in the NoC to perform an atomic operation is below a predetermined quantity and is therefore insufficient to perform the atomic operation and the quantity of the preselected resources of the SoC that is available to perform the atomic operation is above a predetermined quantity and sufficient to perform the atomic operation.

### DESCRIPTION OF THE RELATED ART

A computing device may include multiple processor-based subsystems. Such a computing device may be, for example, a portable computing device (“PCD”), such as a laptop or palmtop computer, a cellular telephone or smartphone, a portable digital assistant, a portable game console, etc. Still other types of PCDs may be included in automotive and Internet-of-Things (“IoT”) applications. A computing device may also be a stationary computer, such as a personal computer (PC) or various types of desktop computers or workstation computers.

Such processor-based subsystems may be included within the same integrated circuit chip or in different chips. A “system-on-a-chip”, or “SoC”, is an example of one such chip that integrates numerous subsystems to provide system-level functionality. For example, an SOC may include one or more types of processors, such as central processing units (“CPU”s), graphics processing units (“GPU”s), digital signal processors (“DSP”s), and neural processing units (“NPU”s). An SOC may include other subsystems as well, such as a transceiver or “modem” subsystem that provides wireless connectivity, a memory subsystem, etc.

SoCs often use memory management units (“MMUs”) to manage writing data to and reading data from one or more physical memory devices, such as random access memory (RAM) devices. An MMU may provide a virtual memory to the CPU of the SoC that allows the CPU to run each application program in its own dedicated, contiguous virtual memory address space rather than having all of the application programs share the physical memory address space, which is often fragmented or non-contiguous. The purpose of such an MMU is to translate a virtual memory address (“VA”) into a physical memory address (“PA”) in response to a read or write operation request from the CPU that identifies the VA. The CPU indirectly reads and writes PAs by directly reading and writing VAs to the MMU, which translates them into PAs and then writes or reads the PAs. Similarly, various systems of a PCD, such as a GPU, a multimedia client system, etc., may include their own system MMUs (“SMMUs”). An SMMU allows the system to operate in its own dedicated, contiguous virtual memory address space by translating VAs into PAs for that system.

SoCs often include a network-on-a-chip (NoC) that interfaces with the SMMU and with various subsystems of the SoC, such as CPUs, GPUs, etc. SMMUs and NoCs work together to optimize data movement, memory access and system performance in SoCs. NoCs comprise a router-based packet switching network that handles communications between the SoC subsystems. The SMMU may work in conjunction with an NoC to perform operations that are generated by application programs being executed by subsystems of the SoC. The operations can be atomic operations, i.e., operations comprising a series of operations that must be treated as a single, indivisible unit of work that cannot be interrupted. The operations can also be normal operations comprising a series of operations that can be divided into multiple units of work that are separately performed.

In some SoC architectures, when an atomic operation is to be performed by the SMMU, the SMMU uses a write buffer/read buffer pair in the NoC to perform the atomic operation. As the number of atomic operations to be performed increases, the number of write buffer/read buffer pairs needed also increases. Situations can arise in which a write buffer/read buffer pair is needed, but is unavailable. This can result in latencies in execution of the application programs.

### SUMMARY OF THE DISCLOSURE

Systems, methods, and other examples are disclosed for dynamically allocating SoC resources for performing atomic operations in the SMMU that would otherwise be performed in the NoC.

An exemplary embodiment of the method comprises, in an SMMU of an SoC, determining whether or not a predetermined quantity of read and write buffer pairs of the NoC is available to perform an atomic operation received from a client of the SoC. The method may further comprise, in the SMMU, determining whether or not a predetermined quantity of underutilized resources of the SoC is available to perform the received atomic operation. The method may further comprise, performing the received atomic operation in the underutilized resources of the SoC in response to determining that the predetermined quantity of read and write buffer pairs of the NoC is not available to perform the received atomic operation and that the predetermined quantity of the underutilized resources is available to perform the received atomic operation.

An exemplary embodiment of the system comprises an SMMU of the SoC comprising logic configured to determine: whether or not a predetermined quantity of read and write buffer pairs of the NoC is available to perform an atomic operation received from a client; whether or not a predetermined quantity of underutilized resources of the SoC external to the NoC is available to perform the received atomic operation; and, in response to determining that the predetermined quantity of read and write buffer pairs of the NoC is not available to perform the received atomic operation and that the predetermined quantity of underutilized resources of the SoC is available to perform the received atomic operation, causing the received atomic operation to be performed using the underutilized resources of the SoC.

An exemplary embodiment of a computer program for execution by a processor for dynamically allocating resources in an SoC to perform atomic operations that would otherwise be performed by an NoC of the SoC. The computer program is embodied on a non-transitory computer-readable medium. The computer instructions comprise a first set of computer instructions for determining whether or not a predetermined quantity of read and write buffer pairs of the NoC is available to perform an atomic operation received in an SMMU from a client of the SoC. The computer instructions may further comprise a second set of instructions for determining whether or not a predetermined quantity of underutilized resources of the SoC is available to perform the received atomic operation. The computer instructions may further comprise a third set of computer instructions for performing the received atomic operation in the underutilized resources of the SoC in response to determining that the predetermined quantity of read and write buffer pairs of the NoC is not available to perform the received atomic operation and that the predetermined quantity of the underutilized resources is available to perform the received atomic operation.

These and other features and advantages will become apparent from the following description, drawings and claims.

### BRIEF DESCRIPTION OF THE DRAWINGS

In the Figures, like reference numerals refer to like parts throughout the various views unless otherwise indicated.

FIG. 1 illustrates a block diagram of a system configured to dynamically allocate walker resources for performing atomic operations in the SMMU that would otherwise be performed in the NoC.

FIG. 2 is a flow diagram of the general process performed by the system shown in FIG. 1 in accordance with a representative embodiment.

FIGS. 3A and 3B together form a flow diagram representing the method performed by the system shown in FIG. 1 that is a modification of the method described above with reference to FIG. 2.

FIGS. 3A and 3C together form a flow diagram similar to the flow diagram formed by FIGS. 3A and 3B, except that FIG. 3C includes additional steps for preventing hazards from occurring and for ensuring that atomic coherence is maintained.

FIGS. 4A and 4B are tables that show the structure of the downstream atomic message packet of the DTI interface 103 shown in FIG. 1 and the corresponding control signals, respectively, in accordance with a representative embodiment.

FIGS. 5A and 5B are tables showing the structure of the upstream atomic message packet of the DTI interface 103 shown in FIG. 1 and the corresponding control signals, respectively, in accordance with a representative embodiment.

FIG. 6 is a block diagram of the TB 101 shown in FIG. 1 in accordance with a representative embodiment having a communication path for transferring atomic operation results performed by the translation controller 120 shown in FIG. 1 from the TB 101 to a client via the client interface 603 shown in FIG. 6.

FIG. 7 shows a table of a TB-to-client response channel message structure and control signals in accordance with a representative embodiment for transferring results over the client interface 603 shown in FIG. 6.

FIG. 8 is a table showing the message packet structure and key control signals used for communications between the translation controller 120 and the NoC 130 shown in FIG. 1 over the ACI interface 131 shown in FIG. 1 in accordance with a representative embodiment.

FIG. 9 illustrates an example of a PCD, such as, for example, a mobile phone or a smartphone, and other devices that incorporate SoCs, in which exemplary embodiments of systems, methods, computer-readable media, and other examples of the inventive principles and concepts of the present disclosure may be implemented in an SoC.

### DETAILED DESCRIPTION

Representative embodiments of the present disclosure are directed to a system and method for dynamically allocating underutilized resources of the SoC for performing atomic operations that would otherwise be performed in the NoC when (1) a predetermined quantity of resources is not available in the NoC to perform an atomic operation and (2) a predetermined quantity of the underutilized resources of the SoC is available to perform the atomic operation.

A detailed discussion of representative embodiments of the system and method are described below with reference to the figures. In the following detailed description, for purposes of explanation and not limitation, exemplary, or representative, embodiments disclosing specific details are set forth to provide a thorough understanding of an embodiment according to the present teachings. The word “exemplary” is used herein to mean “serving as an example, instance, or illustration.” The words “illustrative” or “representative” may be used herein synonymously with “exemplary.” Any aspect described herein as “exemplary” is not necessarily to be construed as preferred or advantageous over other aspects. However, it will be apparent to one having ordinary skill in the art and having the benefit of the present disclosure that other embodiments according to the present teachings that depart from the specific details disclosed herein remain within the scope of the appended claims. Moreover, descriptions of well-known apparatuses and methods may be omitted to not obscure the description of the example embodiments. Such methods and apparatuses are clearly within the scope of the present teachings.

The terminology used herein is for purposes of describing exemplary or representative embodiments only and is not intended to be limiting. The defined terms are in addition to the technical and scientific meanings of the defined terms as commonly understood and accepted in the technical field of the present teachings.

As used in the specification and appended claims, the terms “a,” “an,” and “the” include both singular and plural referents, unless the context clearly dictates otherwise. Thus, for example, “a device” includes one device and plural devices.

Relative terms may be used to describe the various elements' relationships to one another, as illustrated in the accompanying drawings. These relative terms are intended to encompass different orientations of the device and/or elements in addition to the orientation depicted in the drawings.

It will be understood that when an element is referred to as being “connected to” or “coupled to” or “electrically coupled to” another element, it can be directly connected or coupled, or intervening elements may be present.

The term “memory device”, as that term is used herein, is intended to denote a non-transitory computer-readable storage medium that can store computer instructions, or computer code, for execution by one or more processors. References herein to a “memory device” should be interpreted as including one or more memory devices.

A “processor”, as that term is used herein, encompasses an electronic component that can execute a computer program or executable computer instructions. References herein to a computer comprising “a processor” should be interpreted as one or more processors. The processor may for instance be a multi-core processor comprising multiple processing cores, each of which may comprise multiple processing stages of a processing pipeline. A processor may also refer to a collection of processors within a single system or distributed amongst multiple systems.

The term “logic”, as that term is used herein, denotes digital circuits, such as digital gate structures, that are combined and configured in a particular manner to achieve one or more functions. For example, control logic can be a combination of digital circuits that have been combined and configured in a particular manner to achieve one or more control functions, either solely in hardware or in a combination of hardware, software and/or firmware.

A computing device may include multiple subsystems, cores or other components. Such a computing device may be, for example, a personal computing device (PCD), such as a laptop or palmtop computer, a cellular telephone or smartphone, a portable digital assistant, a portable game console, an automotive safety system, etc., or a non-portable computing device (NPCD) such as, for example, a PC, a desktop or a workstation computer.

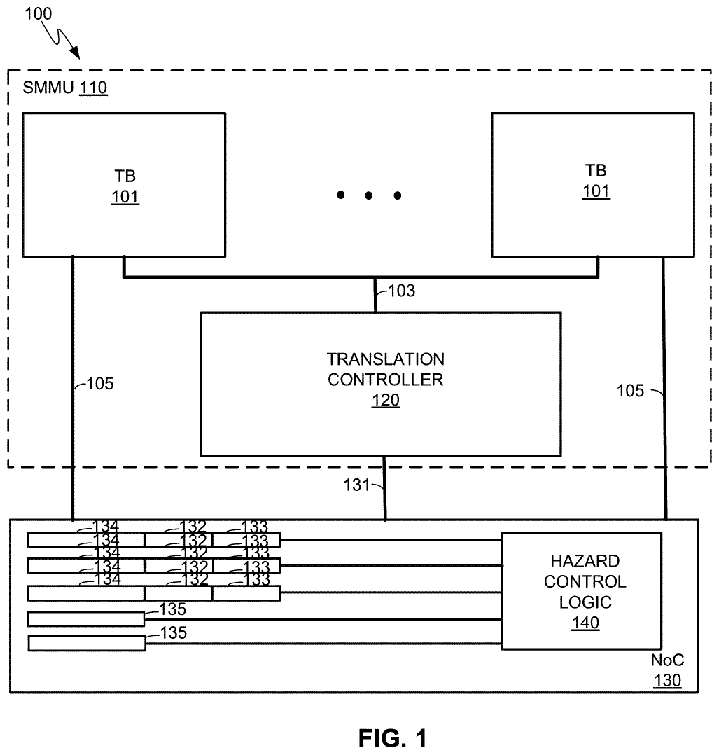

FIG. 1 illustrates a block diagram of a system 100 in accordance with a representative embodiment that is configured to dynamically allocate underutilized resources of the SoC for performing atomic operations that would otherwise be performed in the NoC or suitable interconnect when insufficient resources are available in the NoC or interconnect to perform the atomic operation. In accordance with a preferred embodiment, walker logic of the SMMU is dynamically allocated for performing the atomic operation when the available resources in the NoC or interconnect for performing atomic operations drop below a preselected TH level.

As indicated above, in some SoC architectures, when an atomic operation is to be performed, a write buffer/read buffer pair in the NoC is required to successfully complete the atomic operation. As the number of atomic operations to be performed increases, the number of write buffer/read buffer pairs needed also increases, which can lead to scenarios in which a write buffer/read buffer pair is needed, but is unavailable. This can result in latencies in execution of client application programs in the SoC.

One solution to this problem is to add more write and read buffer pairs to the NoC to increase its capacity to perform operations. Doing so, however, would consume more area in the SoC and increase costs.

The present disclosure provides an alternative solution that does not consume additional area or increase costs. In order to perform the virtual address (VA)-to-physical address (PA) translations, the SMMU accesses page tables, which may be stored in the SoC main memory. The page tables comprise page table entries. The page table entries are information that is used by the SMMU to map the VAs into PAs. The SMMU may include a translation lookaside buffer (“TLB”), which is a cache memory used to store recently used VA-to-PA mappings. When the SMMU needs to translate a VA into a PA, the SMMU first checks the TLB to determine whether there is a match for the VA. If the SMMU finds a match, it uses the mapping found in the TLB to determine the PA and then accesses the PA (i.e., reads or writes the PA). This is known as a TLB “hit.” If the SMMU does not find a match in the TLB, this is known as a TLB “miss.” In the event of a TLB miss, the SMMU performs a method known as a table walk or page walk. In a table or page walk, a walker of the SMMU identifies a page table corresponding to the VA and then reads one or more locations in the page table until the corresponding VA-to-PA mapping is found. The SMMU then uses the mapping to determine the corresponding PA, writes the mapping back to the TLB, and accesses the PA.

Walkers of the SMMU are underutilized. In some cases, mean walker allocation is well below the maximum number of walkers (e.g., 32) contained in the SMMU. The solution of the present disclosure takes advantage of this under-utilization of walker resources by dynamically allocating them for performing atomic operations when the quantity of available resources in the NoC for performing atomic operations drops below a preselected TH level. In this way, the system and method of the present disclosure reduce latencies associated with the performance of atomic operations while also reducing the load on the NoC and servicing higher atomic operations, and these benefits are achieved without consuming more area on the SoC for additional resources and without increasing costs. Representative, or exemplary, embodiments of the system and method will now be described with reference to the figures.

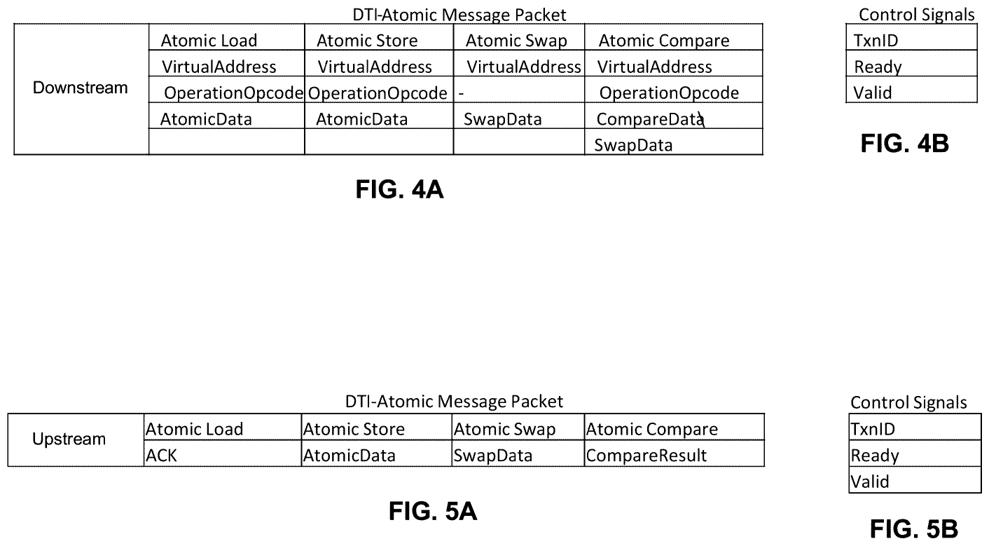

With reference again to FIG. 1, an SMMU 110 of an SoC comprises a plurality of translation buffers (TBs) 101 and a translation controller 120 for performing the aforementioned VA-to-PA translations. The TBs 101 comprise TLBs, command queues (CMDQs) and other logic for performing VA-to-PA mapping and other operations, as will be described below in more detail with reference to FIG. 6. The TBs 101 interface with the translation controller 120 via a distributed translation interface (DTI) 103 that is modified to perform the method of the present disclosure, as will be described below in more detail. The TBs 101 communicate with the NoC 130 of the SoC using NoC socket (NS) protocol packets via an NS interface 105 or via any suitable streaming interface. The NoC 130 interfaces with the translation controller 120 via one of more interfaces 131. The interface 131 can be an atomic coherence interface (ACI) that is incorporated into an Advanced Extensible Interface (AXI), or an AXI Coherency Extensions (ACE) interface, or any other suitable streaming interface, or it can be a separate ACI sideband channel. The DTI, AXI and ACE interface protocols are ARM communications protocols that are known in the art, except that these interfaces are modified to perform the methods of the present disclosure, as will be described below in more detail.

In accordance with a preferred embodiment, the translation controller 120 includes logic for performing atomic operations that are offloaded from the NoC 130 to the translation controller 120. The translation controller 120 also includes logic configured to determine when atomic operations are to be offloaded from the NoC 130 to the translation controller 120.

The NoC 130 includes read buffers 132 and write buffers 133 for performing read and write operations, as well as credit storage elements 134. In accordance with a preferred embodiment of the present disclosure, the NoC 130 also includes “bufferless” storage elements 135 that store context information such as physical addresses, source information, etc. that are offloaded to, and performed by, the translation controller 120. Hazard control logic 140 of the NoC 130 is configured to check the physical addresses contained in the storage elements 135 against physical addresses associated with other operations being performed for other clients of the SoC to make sure they are not the same in order to avoid hazards and ensure atomic coherence.

During operations of the system 100, the translation controller 120 communicates with the TBs 101 to perform VA-to-PA address mapping. For any atomic operation coming to the TBs 101, the TBs 101 send atomic operations to the NoC 130, which are initially loaded into context storage elements 134. The adjacent read/write buffer pair 132, 133 is then used to hold atomic read and write data. When performing the method of the present disclosure, TB 101 communicates with the NoC 130 via interface 105 to determine the availability of read/write buffer pairs 132, 133 for performing atomic operations. When the TB 101 determines, based on these communications, that the availability of read buffer/write buffer pairs 132, 133 has dropped below a predetermined TH level, logic of the TB 101 determines whether the number of walkers of the translation controller 120 currently being utilized is below a TH level.

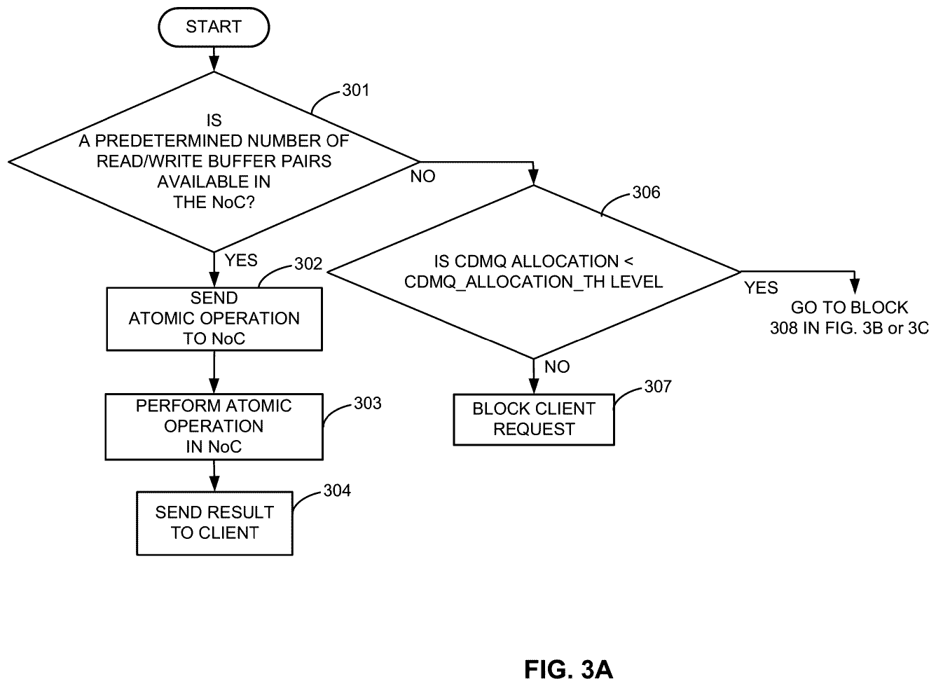

Based on these determinations, the SMMU 110 decides whether or not to allocate walkers to perform atomic operations and offload the atomic operations from the NoC 130 to the translation controller 120. This process can be performed in a number of ways, one of which will be described below with reference to FIGS. 3A-3C, but in general, if the SMMU 110 determines (1) that the availability of read buffer/write buffer pairs 132, 133 in the NoC 130 has dropped below a predetermined TH level and (2) that the quantity of walkers of the translation controller 120 currently being utilized is below another predetermined TH level, atomic operations are sent from the TBs 101 to the translation controller 120 to be performed in the translation controller 120 instead of in the NoC 130. The results of the atomic operations performed by the translation controller 120 are then sent back to the TBs 101, which send them to the clients of the SoC that are performing the corresponding application programs.

Many variations can be made to the process, such as adding steps that prevent application programs of different clients from using the same physical address, referred to herein as a “hazard”, and steps that ensure that atomic coherency is maintained. An embodiment of the process that takes these considerations into account is described below with reference to FIGS. 3A and 3C. The hazard control logic 140 and “bufferless” context storage elements 135, which are used only to store physical addresses or context data associated with atomic operations being performed in the translation controller 120, are used to avoid hazards and to ensure that atomic coherency is maintained.

Each of the TBs 101 includes a CMDQ. The walkers are part of the translation controller 120. The CMDQ controls what is sent to the walkers. The CMDQs are located at the entry of the SMMU 110 where the SMMU 110 interfaces with the clients of the SoC, whereas the walkers follow the CMDQs in the direction of data flow. The CMDQ comprises context buffers that hold the request incoming from the client until the walkers are available and perform address hazarding. With address hazarding, any request from the client that lies within the same address region of an ongoing request will be hazarded, i.e., kept in the CMDQ and not sent to a walker until the previous request has been completed.

The CMDQ performs the check to determine whether an incoming request is a request to perform an atomic operation. The TBs 101 inform the translation controller 120 when an incoming request is a request to perform an atomic operation, which triggers the SMMU 110 to perform the method of determining whether the atomic operation is to be performed by the NoC 130 or is to be offloaded to the translation controller 120. When atomic operation requests are to be completed by the NoC 130, the associated data, operands and VA-to-PA mappings are forwarded over interface 105 from the TBs 101 to the NoC 130. When atomic operation requests are to be performed by the translation controller 120, the associated data, operands and VA-to-PA mappings are forwarded over the DTI interface 103 from the TBs 101 to the translation controller 120.

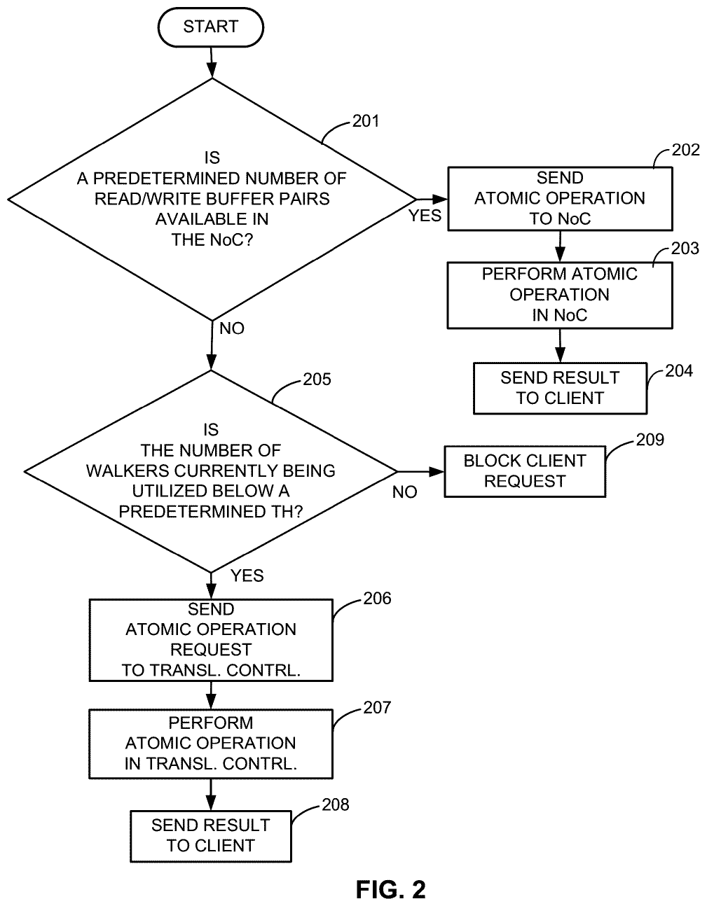

FIG. 2 is a flow diagram of the general process performed by the system 100 shown in FIG. 1 in accordance with a representative embodiment. Block 201 represents the step of the SMMU 110 determining whether or not a predetermined quantity of read buffer/write buffer pairs 132, 133 in the NoC 130 is available to perform the atomic operation. If so, the SMMU 110 causes the TB 101 to send the atomic operation request to the NoC 130, which then performs the atomic operation and sends the results to the corresponding client, as indicated by blocks 202, 203 and 204, respectively.

If at block 201 a determination is made that the predetermined quantity of read buffer/write buffer pairs 132, 133 in the NoC 130 is not available to perform the atomic operation (e.g., no read/write buffer pairs 132, 133 are available), the SMMU 110 determines whether or not the quantity of walkers of the translation controller 120 currently being utilized is below another predetermined TH level, as indicated by block 205. If so, the atomic operation request is sent from the TBs 101 to the translation controller 120 and is performed in the translation controller 120, as indicated by block 206 and 207, respectively. The result is then sent to the client that requested performance of the atomic operation, as indicated by block 208. If not, the client request is blocked, as indicated by block 209.

FIGS. 3A and 3B together form a flow diagram representing the method performed by the system 100 shown in FIG. 1 that is a modification of the method described above with reference to FIG. 2. In accordance with a representative embodiment, a concept referred to herein as “atomic credits” is used to indicate the availability or unavailability of resources for performing atomic operations.

At the step represented by block 301, a determination is made by the SMMU 110 as to whether the NoC 130 has a predetermined quantity of available read/write buffer pairs to perform an atomic operation. In accordance with this embodiment, if the NoC 130 has a single available read/write buffer pair, the atomic operation will not be offloaded to the translation controller 120. If decision block 301 is answered in the affirmative, the process proceeds to blocks 302, 303 and 304 where the atomic operation is sent to the NoC 130, performed in the NoC 130, and the result is sent to the client on completion, respectively.

If it is determined at block 301 that the NoC 130 does not have the predetermined quantity of available resources to perform the atomic operation (e.g., there are no available read/write buffer pairs), then the process proceeds to block 306. Block 306 performs the process of determining whether or not a predetermined quantity of resources in the translation controller 120 is available for performing the atomic operation. CMDQ allocation in the TB 101 should be below a predetermined threshold (TH) level, referred to herein as “CDMQ_ALLOCATION_TH”. CMDQ allocation is an indication of CMDQ occupancy in the TB 101, which is an indication of walker utilization because the CDMQs control what is sent to the walkers of the translation controller 120. In an example implementation, walker occupancy should be sufficiently low that even if a heavy workload starts for the current client, then the translation controller 120 could sustain that workload for a few cycles using the unoccupied walkers. At block 306, a determination is made as to whether current CDMQ allocation is below CDMQ_ALLOCATION_TH. If so, the process proceeds to block 308 of FIG. 3B. This threshold level may be set to, for example, 50% of CMDQ capacity. This can be a static threshold level or the system 100 can use a window-based approach to dynamically change the threshold level during runtime. If the decision of block 306 is decided in the negative, the client request is blocked, as indicated by block 307.

For one example implementation, it was decided that the number of CMDQs serving atomic operations should not be above a predetermined TH level, referred to herein as “CMDQ_ATOMIC_CREDIT”, which is the maximum number of atomic operations the CDMQs of the TBs 101 can serve at any given time. Using this TH level limits the maximum number of atomic operations that can be offloaded to the translation controller 120. This TH level can also be a static TH level or a TH level that can be changed dynamically by the system 100 during runtime after monitoring a time window. At block 308 of FIG. 3B, a determination is made as to whether or not the current number of CDMQs being used to perform atomic operations is below CMDQ_ATOMIC_CREDIT. If not, the client request is blocked, as indicated by block 309. If so, the atomic operation is offloaded to the translation controller 120 and performed by the translation controller 120, as indicated by blocks 310 and 311, respectively. The result is then sent to the client, as indicated by block 312.

FIGS. 3A and 3C together form a flow diagram similar to the flow diagram formed by FIGS. 3A and 3B, except that FIG. 3C includes additional steps for preventing hazards from occurring and for ensuring that atomic coherence is maintained. If a determination is made at block 308 that the current number of CDMQs being used to perform atomic operations is below CMDQ_ATOMIC_CREDIT, then the process proceeds to block 315 at which a hazard CMDQ of the TB 101 is allocated for performing the atomic operation using a walker of the translation controller 120. The atomic operation is transferred from the hazard CDMQ to the translation controller 120 via the DTI interface 103, as indicated by block 316. The translation controller 120 allocates a walker to be used to perform the atomic operation, as indicated by block 317. The walker is then used to translate the VA associated with the atomic operation into a PA, as indicated by block 318.

At block 319, one of the “bufferless” context storage elements 135 in the NoC 130 is allocated and the PA is stored in the allocated context storage element 135. At block 320, the translation controller 320 performs (starts and completes) the atomic operation. The atomic operation request in the translation controller 120 is broken down into read and write operations by the walker allocated at block 317. At block 321, the CMDQ in the TB 101 and the walker in the translation controller 120 are deallocated. At block 322, any CMDQs that were hazarded to avoid multiple clients accessing the same PAs are dehazarded. At block 323, the result is sent via DTI interface 103 to the TB 101, which then sends the result to the client. The interface between the TB 101 and the client is described below in more detail.

As indicated above, the interface 131 is preferably an ACI interface or an ACI sideband channel. Using this interface allows atomic operations that are transferred to the translation controller 120 to be informed at the NoC 130 as the last point of coherence (POC). This allows the hazard control logic 140 to avoid hazards in cases in which multiple channels at the NoC 130 are attempting to have atomic access to the same physical address. The ACI interface 131 provides serialization of atomic operations and provides atomic transfer information for hazarding cross-channel atomics.

The ACI interface 131 also provides a handshaking mechanism needed to ensure atomic coherency. To allow the NoC 130 to act as the last POC, it uses the buffers 132, 133 for holding regular atomic operations owned by the NoC 130 and the bufferless context storage elements 135 for holding the context and control information, but not the data, associated with atomic operations owned by the translation controller 130. The CMDQ can be hazarded if duplicate physical addresses are observed from the same or multiple streams. This structure allows hazarding of any other atomic operations coming from a different client and provides adherence to the laws of POC.

The DTI interface 103 is modified, or extended, to include DTI atomic capability for transferring atomic operations from the TBs 101 to the translation controller 120 that are to be performed in the translation controller 120 and receiving the results from the translation controller 120 in the TBs 101 that are to be sent to the client. This atomic capability can be implemented as a packet-based data structure that can be transferred over an extended DTI interface or as a separate DTI-Atomic side channel between the TBs 101 and the translation controller 120.

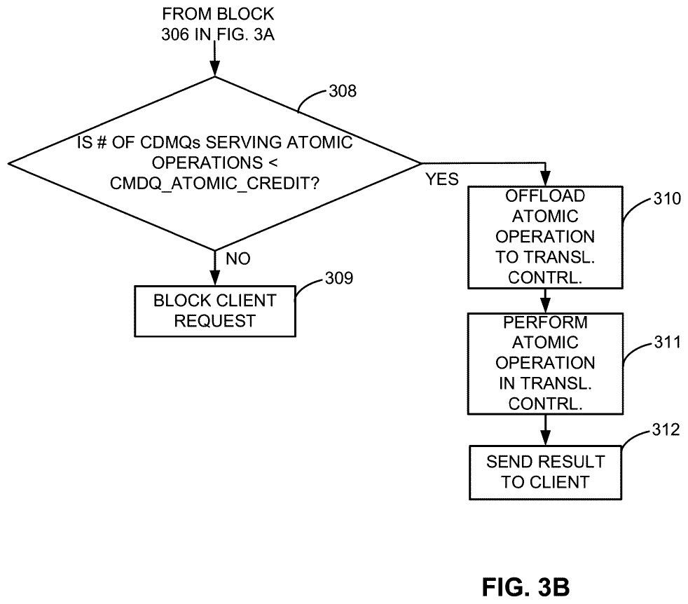

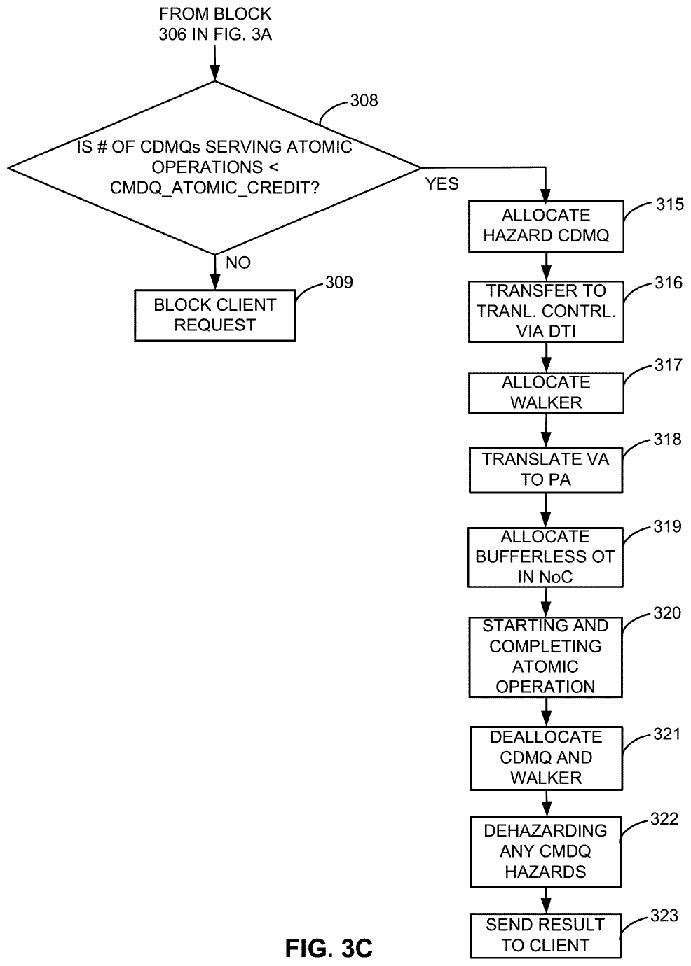

FIGS. 4A and 4B are tables that show the structure of the downstream (TB 101-to-translation controller 120) DTI atomic message packet and the corresponding control signals, respectively, in accordance with a representative embodiment. FIGS. 5A and 5B are tables showing the structure of the upstream (translation controller 120-to-TB 101) DTI atomic message packet and the corresponding control signals, respectively, in accordance with a representative embodiment. The Atomic Load message packet comprises a command to read data from memory, perform an arithmetic operation on the data and return the result to the client. The Atomic Store message packet comprises a command to perform an arithmetic operation and store data in memory. The Atomic Swap message packet comprises a command to write the data at address X and return the previous data at address X to the client. The Atomic Compare message packet comprises a command to compare the data at address X with the incoming data, D1, and if the comparison is true then replace the data at address X with data D2, which is sent along with data D1. It should be noted that the downstream and upstream DTI atomic message packets can have a variety of packet configurations and that the inventive principles and concepts are not limited to the packet configurations shown in FIGS. 4A-5B.

When an atomic operation is performed in the translation controller 120 rather than in the NoC 130, a communication path is needed in the TBs 101 for communicating the result of performing the atomic operation from the TBs 101 back to the client. FIG. 6 is a block diagram of the TB 101 shown in FIG. 1 in accordance with a representative embodiment having such a communication path 600. A TLB 601 of the TB 101 works in conjunction with the walkers of the translation controller 120 to perform VA-to-PA translation and to act as a level 1 cache for storing the translation entries. The CMDQ 602 operates with the walkers of the translation controller 120 in the manner described above to enable atomic operations to be performed in the translation controller 120. A client interface 603 interfaces the TB 101 with the client. A NOC interface 604 corresponding to the interface 105 shown in FIG. 1 interfaces the TB 101 with the NoC 130.

In the downstream direction, a multiplexer/demultiplexer (MUX) 606 multiplexes the contents of the CMDQ 602 based on a control signal (not shown) onto the DTI/Atomic DTI interface 103 to send atomic operation requests stored in the CMDQ 602 to the translation controller 120 to be performed by the translation controller 120. The results are then multiplexed by the MUX 606 into locations in the CMDQ 602. The results are then sent from the CMDQ 602 to the client interface 603 via path 600 for delivery to the client.

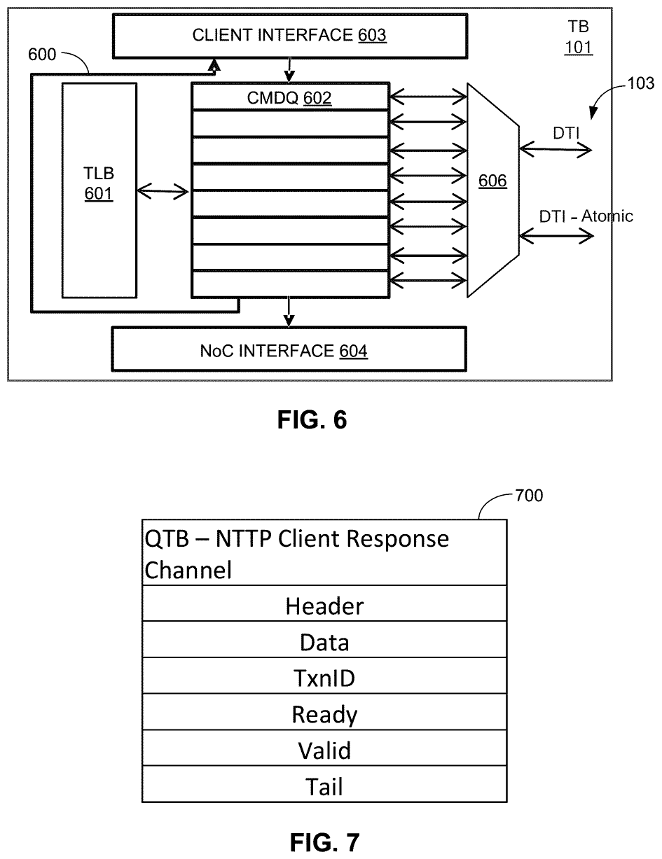

FIG. 7 shows a table 700 of the TB 101-to-client response channel message structure and control signals in accordance with a representative embodiment. Header is the message header indicating the start of the message packet. Data is the data contained in the message packet. TxnID is a unique ID associated with each operation. Ready indicates whether the client is ready to accept the response data. Valid indicates that the response data being sent over the communication channel is valid. Tail indicates the end of the packet. It should be noted that the TB 101-to-client response message packets can have a variety of packet configurations and that the inventive principles and concepts are not limited to the packet configuration shown in FIG. 7.

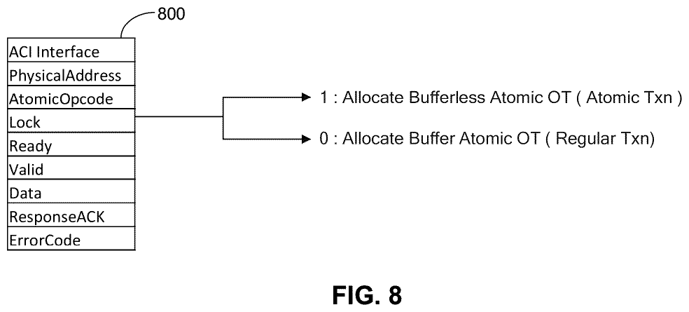

FIG. 8 is a table showing the message packet structure and key control signals used for communications between the translation controller 120 and the NoC 130 over the ACI interface 131 shown in FIG. 1 in accordance with a representative embodiment. PhysicalAddress is the physical address associated with the operation being requested. AtomicOpcode is the atomic operation to be performed on the data contained in the packet. Lock is a bit indicating whether a storage element 135 is being allocated in cases where the atomic operation is being performed in the translation controller 120 or storage elements 132-134 are being allocated when atomic operations are being performed in the NoC 130. Ready indicates whether or not the NoC 130 is ready to accept a request. Valid indicates when there is valid data on the bus 131. ResponseAck is the acknowledgement sent to the walker regarding the allocation of bufferless credits in NoC 130. In scenarios in which the NoC 130 is unable to allocate the bufferless credits or there are some memory read/write errors, then ErrorCode describes the type of error. It should be noted that the ACI message packets can have a variety of packet configurations and that the inventive principles and concepts are not limited to the packet configuration shown in FIG. 8.

It can be seen from the discussion above that the representative embodiments necessitate changes to known specifications for known communications protocols, such as the specifications that govern the DTI and ACI communications protocols. It should be noted, however, that the system and method of the present disclosure can be implemented in other ways using other known communications protocols or even unknown proprietary protocols, as will be understood by those skilled in the art in view of the description provided herein.

It should also be noted that while the representative embodiments have been described with reference to offloading atomic OTs from the NoC 130 to the translation controller 120, the atomic OTs can be offloaded to any suitable logic of the SoC, both internal to and external to the SMMU, as will be understood by those skilled in the art in view of the description provided herein. Persons of skill in the art will also understand that although the inventive principles and concepts have been described with reference to an SMMU, they apply equally to MMUs. For example, logic inside of hardware accelerators and hardware of other SoC clients can be used to perform atomic operations that are offloaded from the NoC 130. Components that perform the handoff should be configurable to hand off atomic operations to another component via a suitable interface. Components that receive the hand off should be (1) capable of performing atomic operations while maintaining coherence when performing operations for multiple clients of the SoC over multiple channels, and (2) reconfigurable from its normal configuration for its normal operations to a configuration that supports atomic operations, and vice versa.

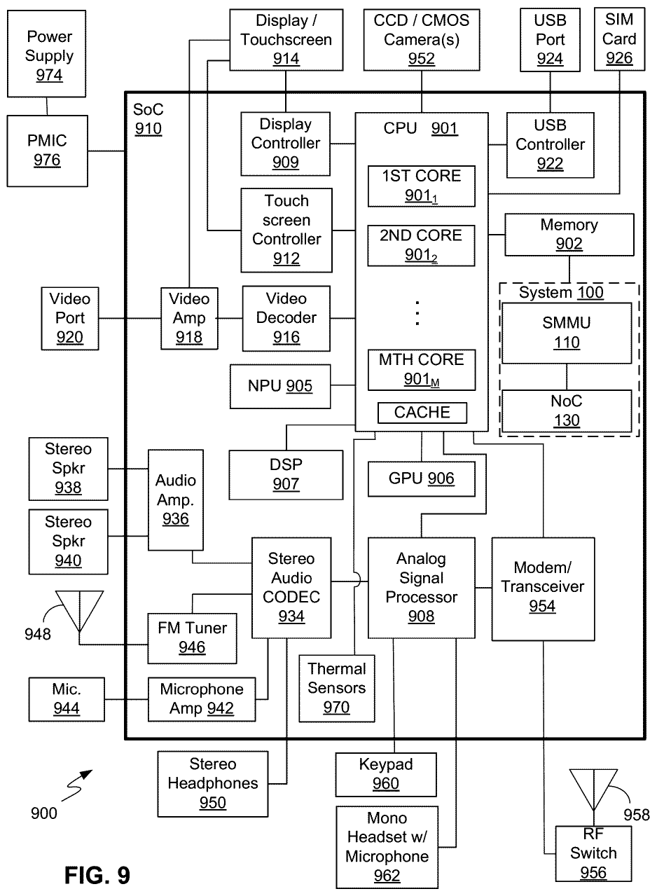

FIG. 9 illustrates an example of a PCD 900, such as, for example, a mobile phone or a smartphone, and other devices that incorporate SoCs, in which exemplary embodiments of systems, methods, computer-readable media, and other examples of the inventive principles and concepts of the present disclosure may be implemented in an SoC 910. The PCD 900 comprises the system 100 shown in FIG. 1. For case of illustration, electrical connections between the system 100 and other components of the SoC 910 are not shown in FIG. 9.

The SoC 910 may include a variety of subsystems, such as, for example, a CPU 901, a memory subsystem comprising SMMU 110 and other memory 902, an NPU 905, a GPU 906, a DSP 907, an analog signal processor 908, a modem/transceiver 954, etc. The CPU 901 may include one or more CPU cores, such as a first CPU core 9011, a second CPU core 9012, etc., through an Mth CPU core 901M.

A display controller 909 and a touch-screen controller 912 may be coupled to the CPU 901. A touchscreen display 914 external to the SoC 910 may be coupled to the display controller 909 and the touch-screen controller 912. The PCD 900 may further include a video decoder 916 coupled to the CPU 901. A video amplifier 918 may be coupled to the video decoder 916 and to the touchscreen display 914. A video port 920 may be coupled to the video amplifier 918. A universal serial bus (“USB”) controller 922 may also be coupled to CPU 901, and a USB port 924 may be coupled to the USB controller 922. A subscriber identity module (“SIM”) card 926 may also be coupled to the CPU 901.

The memory 902 may be coupled to the CPU 901. The memory 902 may include both volatile and non-volatile memories. Examples of volatile memories include static random access memory (“SRAM”) and dynamic random access memory (“DRAM”). The one or more memories may include local cache memory and a system-level cache memory (e.g., level 3 (L3)) cache memory. The CPU 901 may also include cache memory, e.g., level 1 (L1) and level 2 (L2) cache memories.

A stereo audio CODEC 934 may be coupled to the analog signal processor 908. Further, an audio amplifier 936 may be coupled to the stereo audio CODEC 934. First and second stereo speakers 938 and 940, respectively, may be coupled to the audio amplifier 936. In addition, a microphone amplifier 942 may be coupled to the stereo audio CODEC 934, and a microphone 944 may be coupled to the microphone amplifier 942. A frequency modulation (“FM”) radio tuner 946 may be coupled to the stereo audio CODEC 934. An FM antenna 948 may be coupled to the FM radio tuner 946. Further, stereo headphones 950 may be coupled to the stereo audio CODEC 934. Other devices that may be coupled to the CPU 901 include one or more digital (e.g., CCD or CMOS) cameras 952.

The modem/transceiver 954 may be coupled to the analog signal processor 908 and the CPU 901. An RF switch 956 may be coupled to the modem/transceiver 954 and an RF antenna 958. In addition, a keypad 960 and a mono headset with a microphone 962 may be coupled to the analog signal processor 908. The SoC 910 may have one or more internal or on-chip thermal sensors 970. A power supply 974 and a power management integrated circuit (PMIC) 976 may supply power to the SoC 910.

Firmware or software may be stored in any of the above-described memories, or may be stored in a local memory directly accessible by the processor hardware on which the software or firmware executes. The method described above with reference to FIGS. 1-9 may be executed solely in hardware or in a combination of hardware and software and/or firmware. Any software and/or firmware can be stored in any suitable memory device, either local to the subsystem or external to it. Any such memory or other non-transitory storage medium having firmware or software stored therein in computer-readable form may be an example of a non-transitory “computer-readable medium,” as that term is understood in the patent lexicon.

Implementation examples are described in the following numbered clauses:

1. A method for dynamically allocating resources in a system-on-a-chip (SoC) to perform atomic operations, comprising:
in a system memory management unit (SMMU) of the SoC, determining whether or not a predetermined quantity of read and write buffer pairs of a network-on-a-chip (NoC) of the SoC is available to perform an atomic operation received from a client of the SoC;
in the SMMU, determining whether or not a predetermined quantity of underutilized resources of the SoC is available to perform the received atomic operation; and
performing the received atomic operation in the underutilized resources of the SoC in response to determining that the predetermined quantity of read and write buffer pairs of the NoC is not available to perform the received atomic operation and that the predetermined quantity of the underutilized resources is available to perform the received atomic operation.

2. The method of clause 1, wherein the underutilized resources comprise at least a first command queue (CMDQ) of at least a first translation buffer of the SMMU and at least one of a plurality of walkers of a translation controller of the SMMU, wherein when the atomic operation is received in the SMMU, the received atomic operation is initially received in the first translation buffer.

3. The method of any of clause 2, further comprising:
after performing the received atomic operation in said at least a first CMDQ and said at least one of a plurality of walkers, sending a result of performing the received atomic operation to the client.

4. The method of any of clauses 1-3, wherein determining whether or not a predetermined quantity of read and write buffer pairs of the NoC is available to perform the received atomic operation comprises:
determining whether or not at least one read and write buffer pair of the NoC is available to perform the received atomic operation.

5. The method of any of clauses 2-4, wherein said at least a first CMDQ comprises a plurality of CMDQs, and wherein the step of determining whether or not a predetermined quantity of underutilized resources of the SoC is available to perform the received atomic operation comprises:
determining whether a quantity of said plurality of CMDQs that have already been allocated to perform address translation operations is below a CMDQ_Allocation TH level; and
in response to determining that the quantity of said plurality of CMDQs that have already been allocated to perform address translation operations is below the CMDQ_Allocation TH level, determining whether a quantity of said plurality of CMDQs that have already been allocated to perform atomic operations is below a CMDQ_Atomic_Credit TH level.

6. The method of clause 5, further comprising:
in response to determining that the quantity of said plurality of CMDQs that have already been allocated to perform address translation operations is below the CMDQ_Allocation TH level and that the quantity of said plurality of CMDQs that have already been allocated to perform atomic operations is below a CMDQ_Atomic_Credit TH level, performing the received atomic operation using said at least a first CMDQ and said at least one of a plurality of walkers and sending a result of performing the received atomic operation to the client.

7. The method of any of clauses 2-6, wherein performing the received atomic operation using said at least a first CMDQ and said at least one of a plurality of walkers comprises:
allocating one of said plurality of CMDQs to be used as a hazard CMDQ;
transferring the received atomic operation from the first translation buffer to the translation controller;
allocating a first walker of said plurality of walkers to be used to perform the received atomic operation;
translating a virtual address (VA) associated with the received atomic operation into a physical address (PA) associated with the received atomic operation;
allocating a storage element in the NoC for storing the PA and storing the PA in the allocated storage element;
starting performance of the received atomic operation using the first walker;
completing the performance of the received atomic operation using the first walker via one or more read and write operations;
deallocating the first walker after all responses from the NoC are received;
deallocating the allocated CMDQ after the first walker has completed the performance of the received atomic operation using the first walker;
dehazarding any CMDQ hazards; and
causing the result of performing the received atomic operation to be sent to the client via the first translation buffer.

8. The method of any of clauses 2-7, wherein said at least a first translation buffer and the translation controller are interconnected via a standard distributed translation interface (DTI) that has been modified to enable transfer of atomic operations from the first translation buffer to the translation controller and communication of a response back to the first translation buffer from the translation controller, the first translation buffer comprising a client interface and a path that extends between the first CDMQ and the client interface, and wherein the method further comprises:
storing the result in the first CMDQ, and wherein the first translation buffer has a client interface and a path that extends between the first CDMQ and the first translation buffer; and
transferring the result stored in the first CDMQ from the first CMDQ to the client interface over said path.

9. The method of any of clauses 2-8, wherein the translation controller and the NoC are interconnected via a standard atomic coherence interface (ACI) that has been modified to allow a physical address associated with the received atomic operation being performed in the translation controller to be transferred from the translation controller to the NoC, the method further comprising:
sending a physical address associated with the received atomic operation being performed in the translation controller to the NoC via the modified ACI;
storing the physical address in a storage element of the NoC; and
with hazard control logic of the NoC, monitoring physical addresses associated with any other operations being performed by the NoC to determine whether or not the physical address stored in the storage element is the same as a physical address associated with any other operations being performed by the NoC.

10. The method of clause 1, wherein the underutilized resources comprise any component that is configurable to perform atomic operations while maintaining coherence, and that is reconfigurable from a first configuration that supports normal operations of the component to a second configuration that supports atomic operations in the component.

A system for dynamically allocating resources in a system-on-a-chip (SoC) to perform atomic operations, the system comprising:

a system memory management unit (SMMU) of the SoC comprising logic configured to determine:
whether or not a predetermined quantity of read and write buffer pairs of a network-on-a-chip (NoC) of the SoC is available to perform an atomic operation received from a client;
whether or not a predetermined quantity of underutilized resources of the SoC external to the NoC is available to perform the received atomic operation; and
in response to determining that the predetermined quantity of read and write buffer pairs of the NoC is not available to perform the received atomic operation and that the predetermined quantity of underutilized resources of the SoC is available to perform the received atomic operation, causing the received atomic operation to be performed using the underutilized resources of the SoC.

12. The system of clause 11, wherein the atomic operation is received in a first translation buffer of the SMMU, and wherein the underutilized resources of the SoC comprise at least a first command queue (CMDQ) of the first translation buffer of the SMMU and at least one of a plurality of walkers of a translation controller of the SMMU.

13. The system of clause 12, wherein the logic of the SMMU is further configured to cause a result of performing the received atomic operation using said at least a first CMDQ and said at least one of a plurality of walkers to be sent to a client of the SMMU via a client interface.

14. The system of any of clauses 11-13, wherein determining whether or not a predetermined quantity of read and write buffer pairs is available to perform the received atomic operation comprises:

determining whether or not at least one read and write buffer pair of the NoC is available to perform the received atomic operation.

15. The system of any of clauses 12-14, wherein said at least a first CMDQ comprises a plurality of CMDQs, and wherein determining whether or not a predetermined quantity of underutilized resources of the SoC is available to perform the received atomic operation comprises:
determining whether a quantity of said plurality of CMDQs that have already been allocated to perform address translation operations is below a CMDQ_Allocation TH level; and
in response to determining that the quantity of said plurality of CMDQs that have already been allocated to perform address translation operations is below the CMDQ_Allocation TH level, determining whether a quantity of said plurality of CMDQs that have already been allocated to perform atomic operations is below a CMDQ_Atomic_Credit TH level.

16. The system of clause 15, further comprising:
in response to determining that the quantity of said plurality of CMDQs that have already been allocated to perform address translation operations is below the CMDQ_Allocation TH level and that the quantity of said plurality of CMDQs that have already been allocated to perform atomic operations is below the CMDQ_Atomic_Credit TH level, the logic of the SMMU causes the received atomic operation to be performed using said at least a first CMDQ and said at least one of a plurality of walkers and causes the result of performing the received atomic operation using said at least a first CMDQ and said at least one of a plurality of walkers to be sent the client of the SMMU.

17. The system of any of clauses 12-16, wherein performing the received atomic operation using said at least a first CMDQ and said at least one of a plurality of walkers comprises:
allocating one of said plurality of CMDQs to be used as a hazard CMDQ;
transferring the received atomic operation from the first translation buffer to the translation controller;
allocating a first walker of said plurality of walkers to be used to perform the received atomic operation;
translating a virtual address (VA) associated with the received atomic operation into a physical address (PA) associated with the received atomic operation;
allocating a storage element in the NoC for storing the PA and storing the PA in the allocated storage element;
starting performance of the received atomic operation using the first walker;
completing the performance of the received atomic operation using the first walker via one or more read and write operations;
deallocating the first walker after all responses from the NoC are received;
deallocating the allocated CMDQ after the first walker has completed the performance of the received atomic operation using the first walker;
dehazarding any CMDQ hazards; and
causing the result of performing the received atomic operation to be sent to the client via the first translation buffer.

18. The system of any of clauses 12-17, wherein said at least a first translation buffer and the translation controller are interconnected via a standard distributed translation interface (DTI) that has been modified to enable transfer of atomic operations from the first translation buffer to the translation controller and communication of a response back to the first translation buffer from the translation controller, the first translation buffer comprising a client interface and a path that extends between the first CDMQ and the client interface, and wherein the logic of the SMMU is further configured to:
cause the result of performing the received atomic operation using said at least a first CMDQ and said at least one of a plurality of walkers to be stored in the first CMDQ; and
transfer the result stored in the first CDMQ from the first CMDQ to the client interface over said path.

19. The system of any of clauses 12-18, wherein the system further comprises:
a standard atomic coherence interface (ACI) interconnecting the translation controller and the NoC, and wherein the ACI is configured to allow a physical address associated with the received atomic operation being performed using said at least a first CMDQ and said at least one of a plurality of walkers to be transferred from the translation controller to the NoC;
logic of the translation controller configured to cause a physical address associated with the received atomic operation being performed using said at least a first CMDQ and said at least one of a plurality of walkers to be sent from the translation controller to the NoC via the modified ACI;
logic of the NoC configured to store the physical address in a storage element of the NoC; and
hazard control logic of the NoC configured to monitor physical addresses associated with any other operations being performed by the NoC to determine whether or not the physical address stored in the storage element is the same as a physical address associated with any other operations being performed by the NoC.

20. A computer program for dynamically allocating resources in a system-on-a-chip (SoC) to perform atomic operations, the computer program comprising computer instructions for execution by processing logic of the SoC, the computer program being embodied on a non-transitory computer-readable medium, the computer instructions comprising:
a first set of computer instructions for determining whether or not a predetermined quantity of read and write buffer pairs of the NoC is available to perform an atomic operation received in a system memory management unit (SMMU) from a client of the SoC;
a second set of instructions for determining whether or not a predetermined quantity of underutilized resources of the SoC is available to perform the received atomic operation; and
a third set of computer instructions for performing the received atomic operation in the underutilized resources of the SoC in response to determining that the predetermined quantity of read and write buffer pairs of the NoC is not available to perform the received atomic operation and that the predetermined quantity of the underutilized resources is available to perform the received atomic operation.

Alternative embodiments will become apparent to one of ordinary skill in the art to which the invention pertains in view of the present disclosure. Therefore, although selected aspects have been illustrated and described in detail, it will be understood that various substitutions and alterations may be made therein.

What is claimed is:

1. A method for dynamically allocating resources in a system-on-a-chip (SoC) to perform atomic operations, comprising:
in a system memory management unit (SMMU) of the SoC, determining whether or not a predetermined quantity of read and write buffer pairs of a network-on-a-chip (NoC) of the SoC are available to perform an atomic operation received from a client of the SoC;
in the SMMU, determining whether or not a predetermined quantity of underutilized resources of the SoC are available to perform the received atomic operation; and
performing the received atomic operation in the underutilized resources of the SoC in response to determining that the predetermined quantity of read and write buffer pairs of the NoC is not available to perform the received atomic operation and that the predetermined quantity of the underutilized resources is available to perform the received atomic operation.

2. The method of claim 1, wherein the underutilized resources comprise at least a first command queue (CMDQ) of at least a first translation buffer of the SMMU and at least one of a plurality of walkers of a translation controller of the SMMU, wherein when the atomic operation is received in the SMMU, the received atomic operation is initially received in the first translation buffer.

3. The method of claim 2, further comprising:
after performing the received atomic operation in said at least a first CMDQ and said at least one of a plurality of walkers, sending a result of performing the received atomic operation to the client.

4. The method of claim 2, wherein determining whether or not a predetermined quantity of read and write buffer pairs of the NoC are available to perform the received atomic operation comprises:
determining whether or not at least one read and write buffer pair of the NoC is available to perform the received atomic operation.

5. The method of claim 2, wherein said at least a first CMDQ comprises a plurality of CMDQs, and wherein the step of determining whether or not a predetermined quantity of underutilized resources of the SoC is available to perform the received atomic operation comprises:
determining whether a quantity of said plurality of CMDQs that have already been allocated to perform address translation operations is below a CMDQ_Allocation TH level; and
in response to determining that the quantity of said plurality of CMDQs that have already been allocated to perform address translation operations is below the CMDQ_Allocation TH level, determining whether a quantity of said plurality of CMDQs that have already been allocated to perform atomic operations is below a CMDQ_Atomic_Credit TH level.

6. The method of claim 5, further comprising:
in response to determining that the quantity of said plurality of CMDQs that have already been allocated to perform address translation operations is below the CMDQ_Allocation TH level and that the quantity of said plurality of CMDQs that have already been allocated to perform atomic operations is below a CMDQ_Atomic_Credit TH level, performing the received atomic operation using said at least a first CMDQ and said at least one of a plurality of walkers and sending a result of performing the received atomic operation to the client.

7. The method of claim 6, wherein performing the received atomic operation using said at least a first CMDQ and said at least one of a plurality of walkers comprises:
allocating one of said plurality of CMDQs to be used as a hazard CMDQ;
transferring the received atomic operation from the first translation buffer to the translation controller;
allocating a first walker of said plurality of walkers to be used to perform the received atomic operation;
translating a virtual address (VA) associated with the received atomic operation into a physical address (PA) associated with the received atomic operation;
allocating a storage element in the NoC for storing the PA and storing the PA in the allocated storage element;
starting performance of the received atomic operation using the first walker;
completing the performance of the received atomic operation using the first walker via one or more read and write operations;
deallocating the first walker after all responses from the NoC are received;
deallocating the allocated CMDQ after the first walker has completed the performance of the received atomic operation using the first walker;
dehazarding any CMDQ hazards; and
causing the result of performing the received atomic operation to be sent to the client via the first translation buffer.

8. The method of claim 3, wherein said at least a first translation buffer and the translation controller are interconnected via a standard distributed translation interface (DTI) that has been modified to enable transfer of atomic operations from the first translation buffer to the translation controller and communication of a response back to the first translation buffer from the translation controller, the first translation buffer comprising a client interface and a path that extends between the first CDMQ and the client interface, and wherein the method further comprises:
storing the result in the first CMDQ, and wherein the first translation buffer has a client interface and a path that extends between the first CDMQ and the first translation buffer; and
transferring the result stored in the first CDMQ from the first CMDQ to the client interface over said path.

9. The method of claim 8, wherein the translation controller and the NoC are interconnected via a standard atomic coherence interface (ACI) that has been modified to allow a physical address associated with the received atomic operation being performed in the translation controller to be transferred from the translation controller to the NoC, the method further comprising:
sending a physical address associated with the received atomic operation being performed in the translation controller to the NoC via the modified ACI;
storing the physical address in a storage element of the NoC; and
with hazard control logic of the NoC, monitoring physical addresses associated with any other operations being performed by the NoC to determine whether or not the physical address stored in the storage element is the same as a physical address associated with any other operations being performed by the NoC.

10. The method of claim 1, wherein the underutilized resources comprise any component that is configurable to perform atomic operations while maintaining coherence, and that is reconfigurable from a first configuration that supports normal operations of the component to a second configuration that supports atomic operations in the component.

11. A system for dynamically allocating resources in a system-on-a-chip (SoC) to perform atomic operations, the system comprising:
a system memory management unit (SMMU) of the SoC comprising logic configured to determine:
whether or not a predetermined quantity of read and write buffer pairs of a network-on-a-chip (NoC) of the SoC is available to perform an atomic operation received from a client;
whether or not a predetermined quantity of underutilized resources of the SoC external to the NoC is available to perform the received atomic operation; and
in response to determining that the predetermined quantity of read and write buffer pairs of the NoC is not available to perform the received atomic operation and that the predetermined quantity of underutilized resources of the SoC is available to perform the received atomic operation, causing the received atomic operation to be performed using the underutilized resources of the SoC.

12. The system of claim 11, wherein the atomic operation is received in a first translation buffer of the SMMU, and wherein the underutilized resources of the SoC comprise at least a first command queue (CMDQ) of the first translation buffer of the SMMU and at least one of a plurality of walkers of a translation controller of the SMMU.

13. The system of claim 12, wherein the logic of the SMMU is further configured to cause a result of performing the received atomic operation using said at least a first CMDQ and said at least one of a plurality of walkers to be sent to a client of the SMMU via a client interface.

14. The system of claim 13, wherein determining whether or not the predetermined quantity of read and write buffer pairs is available to perform the received atomic operation comprises:
determining whether or not at least one read and write buffer pair of the NoC is available to perform the received atomic operation.

15. The system of claim 12, wherein said at least a first CMDQ comprises a plurality of CMDQs, and wherein determining whether or not the predetermined quantity of underutilized resources of the SoC is available to perform the received atomic operation comprises:
determining whether or not a quantity of said plurality of CMDQs that have already been allocated to perform address translation operations is below a CMDQ_Allocation TH level; and
in response to determining that the quantity of said plurality of CMDQs that have already been allocated to perform address translation operations is below the CMDQ_Allocation TH level, determining whether or not a quantity of said plurality of CMDQs that have already been allocated to perform atomic operations is below a CMDQ_Atomic_Credit TH level.

16. The system of claim 15, further comprising:
in response to determining that the quantity of said plurality of CMDQs that have already been allocated to perform address translation operations is below the CMDQ_Allocation TH level and that the quantity of said plurality of CMDQs that have already been allocated to perform atomic operations is below the CMDQ_Atomic_Credit TH level, the logic of the SMMU causes the received atomic operation to be performed using said at least a first CMDQ and said at least one of a plurality of walkers and causes the result of performing the received atomic operation using said at least a first CMDQ and said at least one of a plurality of walkers to be sent the client of the SMMU.

17. The system of claim 16, wherein performing the received atomic operation using said at least a first CMDQ and said at least one of a plurality of walkers comprises:
allocating one of said plurality of CMDQs to be used as a hazard CMDQ;
transferring the received atomic operation from the first translation buffer to the translation controller;
allocating a first walker of said plurality of walkers to be used to perform the received atomic operation;
translating a virtual address (VA) associated with the received atomic operation into a physical address (PA) associated with the received atomic operation;
allocating a storage element in the NoC for storing the PA and storing the PA in the allocated storage element;
starting performance of the received atomic operation using the first walker;
completing the performance of the received atomic operation using the first walker via one or more read and write operations;
deallocating the first walker after all responses from the NoC are received;
deallocating the allocated CMDQ after the first walker has completed the performance of the received atomic operation using the first walker;
dehazarding any CMDQ hazards; and
causing the result of performing the received atomic operation to be sent to the client via the first translation buffer.

18. The system of claim 13, wherein said at least a first translation buffer and the translation controller are interconnected via a standard distributed translation interface (DTI) that has been modified to enable transfer of atomic operations from the first translation buffer to the translation controller and communication of a response back to the first translation buffer from the translation controller, the first translation buffer comprising a client interface and a path that extends between the first CDMQ and the client interface, and wherein the logic of the SMMU is further configured to:
cause the result of performing the received atomic operation using said at least a first CMDQ and said at least one of a plurality of walkers to be stored in the first CMDQ; and
transfer the result stored in the first CDMQ from the first CMDQ to the client interface over said path.

19. The system of claim 18, wherein the system further comprises:
a standard atomic coherence interface (ACI) interconnecting the translation controller and the NoC, and wherein the ACI is configured to allow a physical address associated with the received atomic operation being performed using said at least a first CMDQ and said at least one of a plurality of walkers to be transferred from the translation controller to the NoC;
logic of the translation controller configured to cause a physical address associated with the received atomic operation being performed using said at least a first CMDQ and said at least one of a plurality of walkers to be sent from the translation controller to the NoC via the modified ACI;
logic of the NoC configured to store the physical address in a storage element of the NoC; and
hazard control logic of the NoC configured to monitor physical addresses associated with any other operations being performed by the NoC to determine whether or not the physical address stored in the storage element is the same as a physical address associated with any other operations being performed by the NoC.

20. A computer program for dynamically allocating resources in a system-on-a-chip (SoC) to perform atomic operations, the computer program comprising computer instructions for execution by processing logic of the SoC, the computer program being embodied on a non-transitory computer-readable medium, the computer instructions comprising:
a first set of computer instructions for determining whether or not a predetermined quantity of read and write buffer pairs of the NoC is available to perform an atomic operation received in a system memory management unit (SMMU) from a client of the SoC;
a second set of instructions for determining whether or not a predetermined quantity of underutilized resources of the SoC is available to perform the received atomic operation; and
a third set of computer instructions for performing the received atomic operation in the underutilized resources of the SoC in response to determining that the predetermined quantity of read and write buffer pairs of the NoC is not available to perform the received atomic operation and that the predetermined quantity of the underutilized resources is available to perform the received atomic operation.
